(19) United States
(12) Patent Application Publication
(10) Pub. No.: US 2016/0195212 A1
(43) Pub. Date: Jul. 7, 2016

(54) Obstructive Tap and Sleeve

(71) Applicant: Tim Zanelli, North Reading, MA (US)

(72) Inventor: Tim Zanelli, North Reading, MA (US)

(21) Appl. No.: 14/677,008

(22) Filed: Apr. 2, 2015

Related U.S. Application Data
(60) Provisional application No. 62/100,501, filed on Jan. 7, 2015.

(51) Int. Cl. F16L 55/18; F16L 55/07; F16L 1/028

(52) U.S. Cl. CPC F16L 55/18; F16L 1/028; F16L 55/07

(57) ABSTRACT

A modified tap and sleeve valve assembly for installation or use in underground small, tight installation or repair areas. The modified tap and sleeve allows the water main tapping process to take place on the top of the water main to allow the water to come out the side, across from the main. This process also allows the user to use a traditional mechanical joint valve instead of the more expensive flange valve.

### CROSS REFERENCE TO RELATED APPLICATION

This application claims the benefit of U.S. Provisional Patent Application No.: 62/100,501 filed on Jan. 7, 2015, the contents of which are incorporated herein by reference.

### FIELD OF THE INVENTION

This invention relates to modified tap and sleeve for installation or repair of underground water supply pipes in obstructive, tight, and confined spaces.

### BACKGROUND OF INVENTION

Cities and towns have multiple pipes, wires, and other supply lines installed and organized underground for aesthetic, protective, and other practical purposes.

These may include, but are not limited to: water supply pipes, sewage or drainage pipes, gas pipes, cable lines, fiber optic lines, power lines, and other utility lines.

Underground installation of these systems is more visually pleasing to residents and visitors compared to above ground installation. Underground installation protects these systems from the natural elements, including interferences from animals. Underground installation protects people and properties from human accidents, exposures to leaks, explosions, or breakdowns in these systems. Finally, underground installation allows gas and water supply lines to work with gravity in moving these liquids across long distances to building structures.

It is highly expensive to make changes to these systems, since they contain highly organized combinations of old and new utility and supply lines; and are usually covered with several feet of soil, concrete, or asphalt.

Access to these supply and utility lines is often needed to make repairs or to install new lines during the building of new or upgraded structures. During the underground installation or repairs of these systems, water mains must often be tapped and sleeved to keep water flowing to local structures during work on the system; or a tapping sleeve valve must be positioned above the main water line for connecting the main water line to the new branch water pipes for new building constructions.

These tapping sleeve valves are typically comprised of stainless or carbon steel.

The valves are installed over water mains in a “T” shape that extends from the top of the water main pipe. The main water line is then tapped in a sealed manner allowing water to flow into the branch pipe via the tapping sleeve and the tapping valve combination.

The sleeve is usually attached to the tapping valve by means of a flange welded to the tapping sleeve valve's branch pipe and connected to the tapping valve by plural nut and bolt combinations. In order to reduce costs, mechanical joints are increasingly being used in combination with the tapping sleeve valves. The use of a mechanical joint standardizes the tapping sleeve valve connection and avoids the requirement for expensive flange valves.

However, there are instances in which the underground spaces between the water main pipe and the installation or repair areas are too small or tight to put in a traditional tapping sleeve valve.

Accordingly, the subject invention is a modified tap and sleeve valve for installation or use in underground obstructive, small, and tight installation or repair areas. The modified tap and sleeve allows the water main tapping process to take place on the top of the water main to allow the water to come out the side, across from the main. This process also allows the user to use a traditional mechanical joint (MJ) valve instead of the more expensive flange valve.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting

The subject invention discloses a tapping sleeve assembly for direct connection to a fluid supply line, said assembly including: a first conduit; a second conduit attached to the first conduit in a first substantially perpendicular direction; a third conduit attached to the second conduit in a second substantially perpendicular direction, wherein the second substantially perpendicular direction is substantially perpendicular to the first substantially perpendicular direction and substantially perpendicular to the first conduit.

A further embodiment of the subject invention discloses a tapping sleeve assembly for direct connection to a fluid supply line, said assembly including: a first conduit; a second conduit attached to the first conduit in a first direction that is substantially ninety degrees; a third conduit attached to the second conduit in a second direction, wherein the second direction is substantially ninety degrees to the first direction and substantially ninety degrees to the first conduit.

Another embodiment of the subject invention discloses a tapping sleeve assembly for direct connection to a fluid supply line, said assembly including: a first conduit; a second conduit attached to the first conduit in a vertical substantially perpendicular direction; a third conduit attached to the second conduit in a horizontal substantially perpendicular direction, wherein the horizontal substantially perpendicular direction is also substantially perpendicular to the first conduit.

A further embodiment of the subject invention discloses a tapping sleeve assembly for direct connection to a fluid supply line, said assembly including: a first conduit; a second conduit attached to the first conduit in a first direction that is substantially vertically ninety degrees; a third conduit attached to the second conduit in a second direction, wherein the second direction is substantially horizontal ninety degrees to the second conduit and substantially ninety degrees to the first conduit.

An embodiment of the subject invention discloses a tapping sleeve assembly for direct connection to a fluid supply line, said assembly including: a first conduit; a second conduit attached to the first conduit in a first direction that is at least seventy-five degrees; a third conduit attached to the second conduit in a second direction, wherein the second direction is at least seventy-five degrees to the first direction and at least seventy-five degrees to the first conduit.

A further embodiment of the subject invention discloses a tapping sleeve assembly for direct connection to a fluid supply line, said assembly including: a first conduit; a second conduit attached to the first conduit in a first direction that is vertically at least seventy-five degrees; a third conduit attached to the second conduit in a second direction, wherein the second direction is horizontal at least seventy-five degrees to the second conduit and at least seventy-five degrees to the first conduit.

Another embodiment of the subject invention discloses a tapping sleeve assembly for direct connection to a mechanical joint gate valve on a water supply line, said assembly including: a main pipe; a first branch pipe attached to the main pipe in a first substantially perpendicular direction; a second branch pipe attached to the first branch pipe in a second substantially perpendicular direction, wherein the second substantially perpendicular direction is substantially perpendicular to the first substantially perpendicular direction and substantially perpendicular to the main pipe, and further wherein the second branch pipe comprises a mechanical joint gate valve adaptor.

A further embodiment of the subject invention discloses a tapping sleeve assembly for direct connection to a mechanical joint gate valve on a water main supply line, said assembly including: a main pipe, a first branch pipe attached to the main pipe in a first direction that is substantially ninety degrees; a second branch pipe attached to the first branch pipe in a second direction, wherein the second direction is substantially ninety degrees to the first direction and substantially ninety degrees to the main pipe, and further wherein the second branch pipe comprises a mechanical joint gate valve adaptor.

An embodiment of the subject invention discloses a tapping sleeve assembly for direct connection to a mechanical joint gate valve on a water supply line, said assembly including: a main pipe; a first branch pipe attached to the main pipe in a vertical substantially perpendicular direction; a second branch pipe attached to the first branch pipe in a horizontal substantially perpendicular direction, wherein the horizontal substantially perpendicular direction is also substantially perpendicular to the main pipe, and further wherein the second branch pipe comprises a mechanical joint gate valve adaptor.

A further embodiment of the subject invention discloses a tapping sleeve assembly for direct connection to a mechanical joint gate valve on a water main supply line, said assembly including: a main pipe, a first branch pipe attached to the main pipe in a first direction that is at least seventy-five degrees; a second branch pipe attached to the first branch pipe in a second direction, wherein the second direction is at least at least seventy-five degrees to the first direction and at least seventy-five degrees to the main pipe, and further wherein the second branch pipe comprises a mechanical joint gate valve adaptor.

Another embodiment of the subject invention discloses a tapping sleeve assembly for direct connection to a mechanical joint gate valve on a water supply line, said assembly including: a main sleeve attached to and substantially aligned with a water supply line pipe; a first outlet conduit attached to and extending outwardly from the main pipe in a first substantially perpendicular direction; a second outlet conduit attached to and extending outwardly from the first outlet conduit in a second substantially perpendicular direction, wherein the second substantially perpendicular direction is substantially perpendicular to the first substantially perpendicular direction and substantially perpendicular to the main sleeve, wherein the second outlet conduit comprises a mechanical joint gate valve adaptor, and further wherein the second outlet conduit terminates in an outlet at a distal end.

A further embodiment of the subject invention discloses a tapping sleeve assembly for direct connection to a mechanical joint gate valve on a water supply line, said assembly including: a main sleeve attached to and substantially aligned with a water supply line pipe; a first outlet conduit attached to and extending outwardly from the main pipe in a vertical substantially perpendicular direction; a second outlet conduit attached to and extending outwardly from the first outlet conduit in a horizontal substantially perpendicular direction, wherein the horizontal substantially perpendicular direction is also substantially perpendicular to the main sleeve, wherein the second outlet conduit comprises a mechanical joint gate valve adaptor, and further wherein the second outlet conduit terminates in an outlet at a distal end.

Another embodiment of the subject invention discloses a tapping sleeve assembly for direct connection to a mechanical joint gate valve on a water supply line, said assembly including: a main sleeve attached to and substantially aligned with a water supply line pipe; a first outlet conduit attached to and extending outwardly from the main pipe in a vertical direction of at least seventy-five degrees; a second outlet conduit attached to and extending outwardly from the first outlet conduit in a horizontal direction of at least seventy-five degrees, wherein the horizontal direction is also at least seventy-five degrees to the main sleeve, wherein the second outlet conduit comprises a mechanical joint gate valve adaptor, and further wherein the second outlet conduit terminates in an outlet at a distal end.

An additional embodiment of the subject invention discloses a tapping sleeve assembly for direct connection to a mechanical joint gate valve on a water supply line, said assembly including: a main sleeve attached to and substantially aligned with a water supply line pipe in a substantially water-tight seal; a first pipe attached to and extending outwardly from the main pipe in a first substantially perpendicular direction in a substantially water-tight seal; a second pipe attached to and extending outwardly from the first pipe in a second substantially perpendicular direction in a substantially water-tight seal, wherein the second substantially perpendicular direction is substantially perpendicular to the first substantially perpendicular direction and substantially perpendicular to the main sleeve, wherein the second pipe comprises a mechanical joint gate valve adaptor, and further wherein the second pipe terminates in an outlet at a distal end.

A further embodiment of the subject invention discloses a tapping sleeve assembly for direct connection to a mechanical joint gate valve on a water supply line, said assembly including: a main sleeve in fluid communication with and substantially aligned with a water supply line pipe; a first outlet conduit in fluid communication with and extending outwardly from the main pipe in a first substantially perpendicular direction; a second outlet conduit in fluid communication with and extending outwardly from the first outlet conduit in a second substantially perpendicular direction, wherein the second substantially perpendicular direction is substantially perpendicular to the first substantially perpendicular direction and substantially perpendicular to the main sleeve, wherein the second outlet conduit comprises a mechanical joint gate valve adaptor, and further wherein the second outlet conduit terminates in an outlet at a distal end.

In further embodiments of the subject invention, each of the tapping sleeve assemblies may be comprised of machined steel.

In other embodiments of the subject invention, the second pipe may extend outwardly from the first pipe, four to six inches above the main pipe.

In additional embodiments of the subject invention, each the mechanical joint gate valve adaptors may further comprise a flange with bolt receiving passages therethrough, and a substantially circular spout extending axially of the flange.

In further embodiments of the subject invention, the second pipe may comprise an external gasket.

In further embodiments of the subject invention, the first pipe may comprise an external gasket and a flange with bolt receiving passages therethrough.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a top perspective view of an obstructive tap and sleeve.

FIG. 2 illustrates a front view of the obstructive tap and sleeve.

FIG. 3 illustrates a rear view of the obstructive tap and sleeve.

FIG. 4 illustrates a top view of the obstructive tap and sleeve.

FIG. 5 illustrates a bottom view of the obstructive tap and sleeve.

FIG. 6 illustrates a left side view of the obstructive tap and sleeve.

FIG. 7 illustrates a top perspective view of another embodiment of the obstructive tap and sleeve.

FIG. 8 illustrates a front view of the other embodiment of the obstructive tap and sleeve.

FIG. 9 illustrates a front view of a wedge gate valve with mechanical joint end.

FIG. 10 illustrates a side view of a wedge gate valve with mechanical joint end.

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

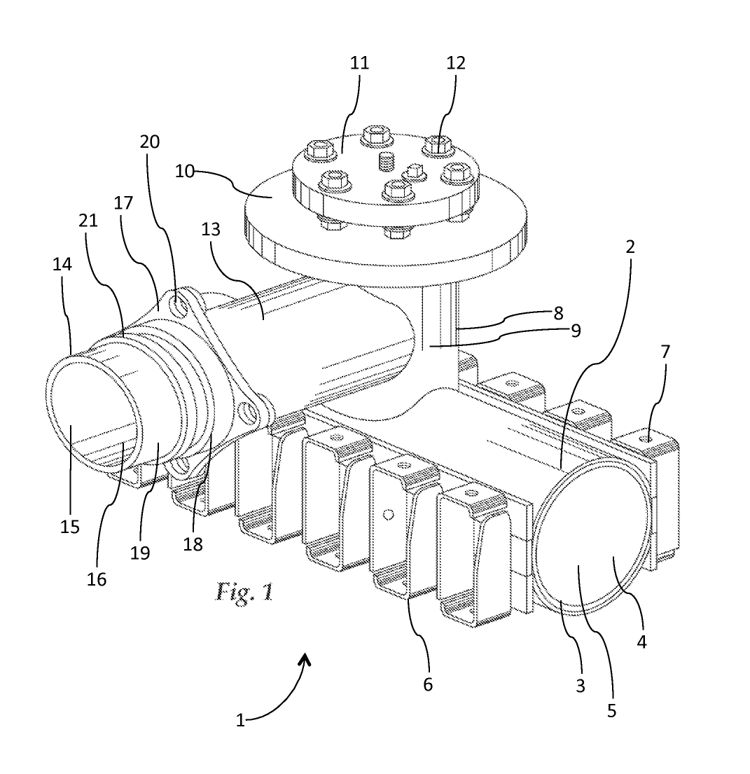

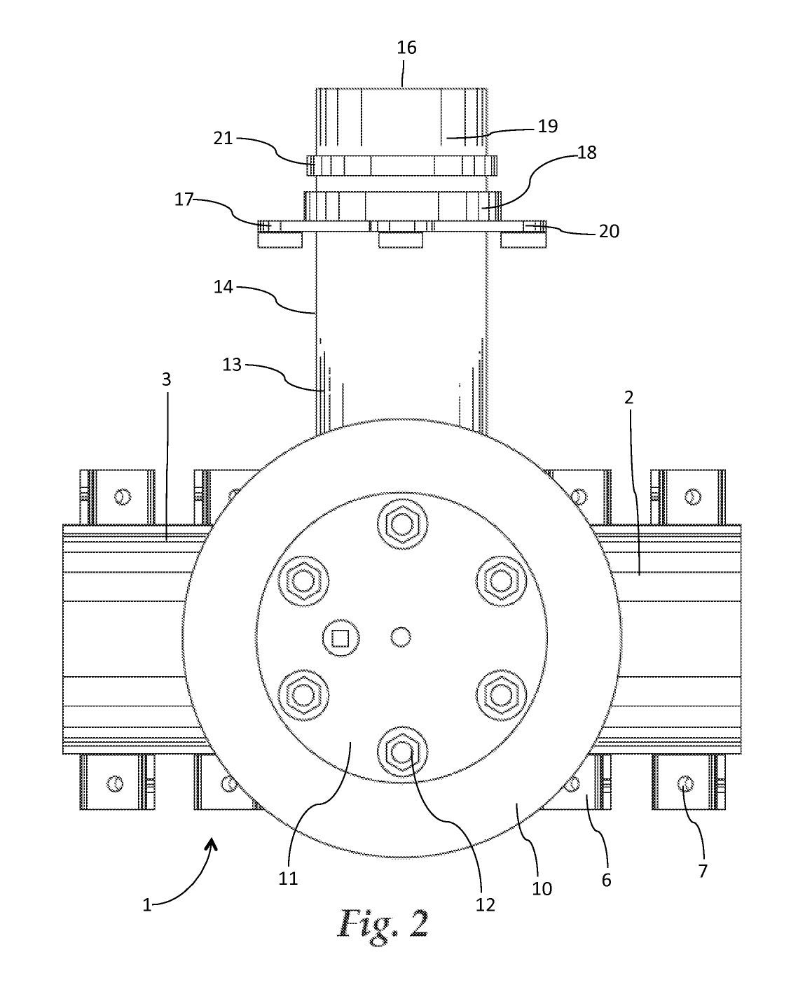

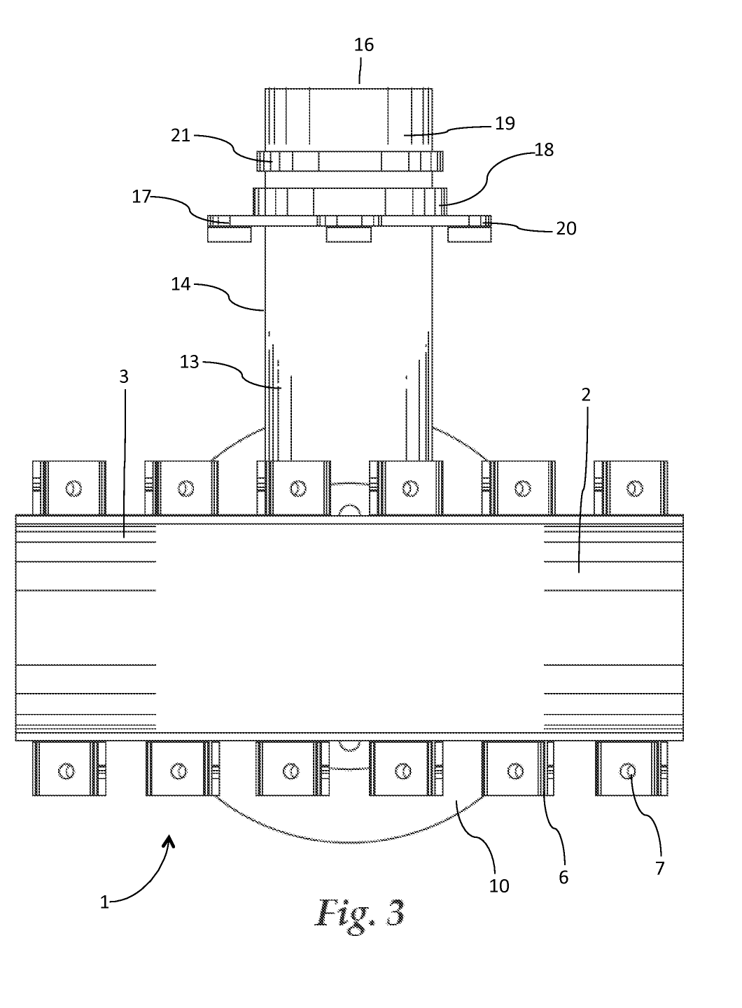

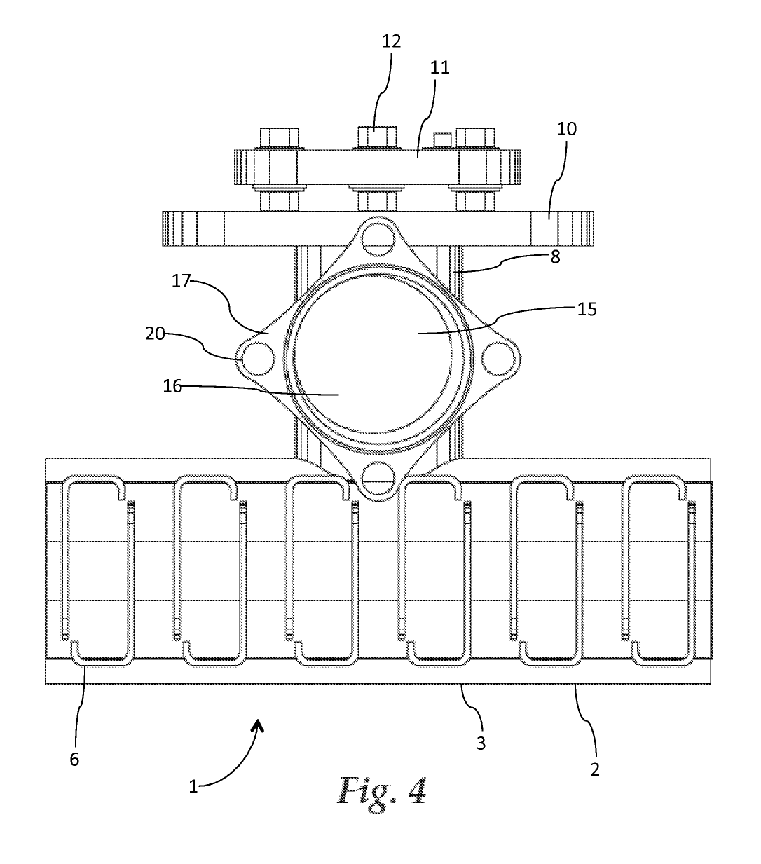

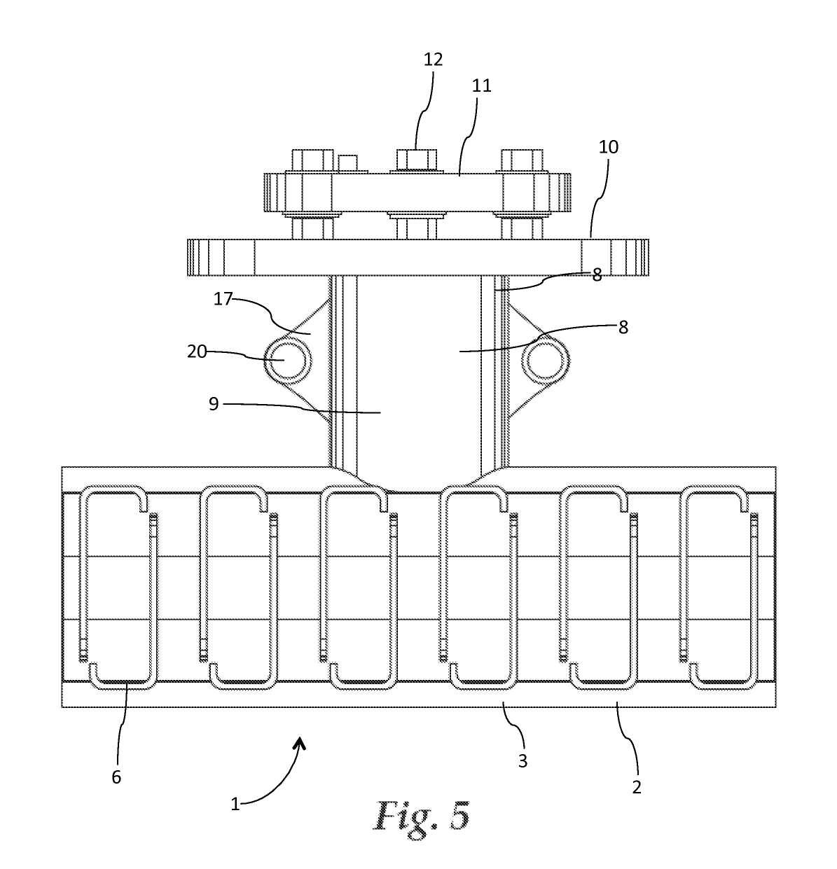

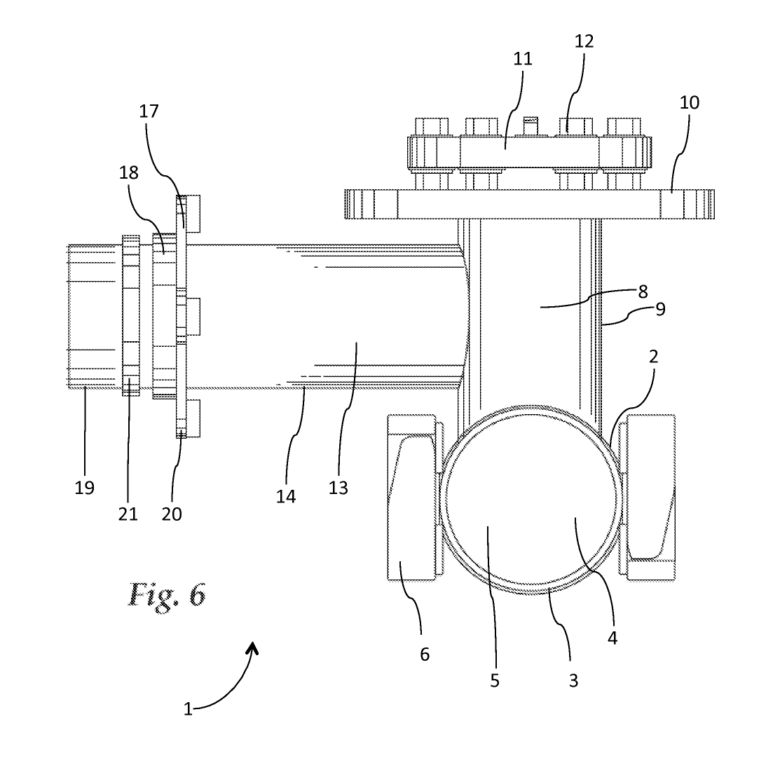

The subject invention discloses a modified tap and sleeve valve 1, illustrated in FIGS. 1-8, for installation or use in obstructive, small, tight, or confined underground main fluid supply lines (not shown).

The tap and sleeve valve 1 is adapted for installation onto a main fluid supply line by means of a hollow substantially cylindrical body 2. In embodiments of the subject invention, the body 2 may be formed of one or more substantially semi-cylindrical sections. In further embodiments of the subject invention, smaller diameter tap and sleeve valves may have a single substantially cylindrical body 2. The body 2 comprises one or more arcuate walls 3 surrounding an internal passage 4, and substantially circular openings 5 on either side of the body 2 to permit fluids to flow in either direction through body 2 once installed over the main fluid supply line.

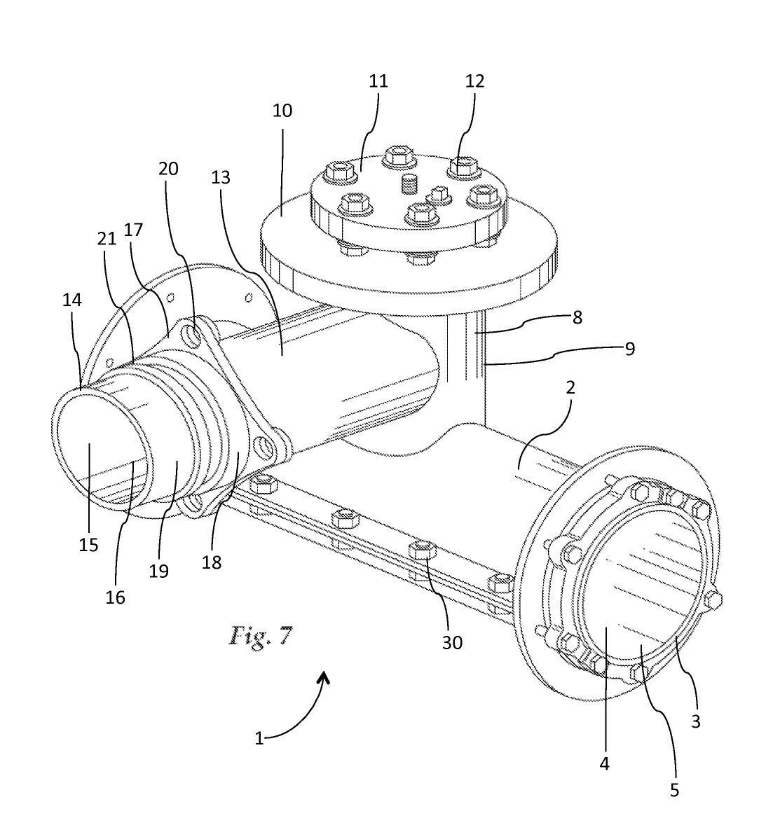

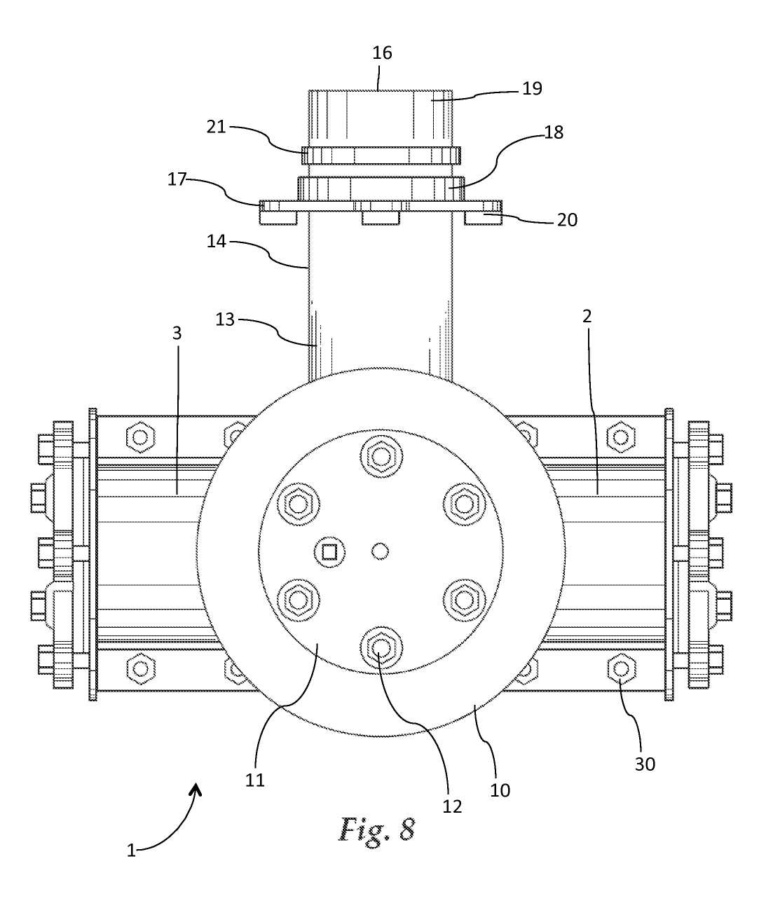

The body 2 further includes a plurality of bolt lugs 6 for receiving a plurality of bolts or other fasteners (not shown). A plurality of holes 7 are provided through the bolt lugs 6 for receiving the bolts. Bolts pass through the aligned holes 7 in the bolt lugs, through washers, also not shown, and through nuts threaded on the bolts to secure the body 2 in substantially watertight contact with the main fluid supply line. In other embodiments of the subject invention, shown in FIGS. 7 and 8, a plurality of aligned holes (not shown) are provided for receiving bolts 30.

A first hollow, substantially cylindrical, branch pipe 8 is attached to the body 2 in a first substantially perpendicular direction. In embodiments of the subject invention, the branch pipe 8 may be formed of one or more substantially semi-cylindrical sections. The branch pipe 8 comprises one or more arcuate walls 9 surrounding a substantially cylindrical internal passage (not shown), and substantially circular internal openings on either side of the branch pipe 8 to permit fluids to flow in either direction through branch pipe 8. The first internal opening of the branch pipe 8 opens to the internal passage 4 of the body 2. The second internal opening of the branch pipe 8 opens to the internal passage 15 of the second branch pipe 13 (described in more detail below). In embodiments of the subject invention, the first and second internal openings of the branch pipe 8 may contain internal substantially circular gaskets (not shown). In further embodiments of the subject invention, the branch pipe 8 may be welded to the body 2, or the body and branch pipe 8 may be molded from a single piece of iron or steel.

Also disposed tightly about the outer surface walls 9 of the branch pipe 8 is a substantially circular gasket 10. In embodiments of the subject invention, the gasket 10 is preferably comprised of rubber, nitrile or elastomeric material.

Above the gasket 10 is a substantially circular flange plate 11 that includes a plurality of apertures each adapted to receive a nut and bolt combination 12 for securely attaching the flange plate 11 onto a live main fluid supply line.

A second hollow, substantially cylindrical, branch pipe 13 is attached to the first branch pipe 8 in a second substantially perpendicular direction. In embodiments of the subject invention, the second branch pipe 13 is substantially perpendicular to both the first branch pipe 8 and the body 2. In further embodiments of the subject invention, the second branch pipe 13 branches off from the first branch pipe, four to five inches above the body 2.

In further embodiments of the subject invention, the branch pipe 13 may be formed of one or more substantially semi-cylindrical sections. The branch pipe 13 comprises one or more arcuate walls 14 surrounding a substantially cylindrical internal passage 15, and substantially circular openings on either side of the branch pipe 13 to permit fluids to flow in either direction through branch pipe 13. The first opening (not shown) of the branch pipe 13 opens to the internal passage of the first branch pipe 8. The second opening of the branch pipe 13 is an outlet aperture 16. In further embodiments of the subject invention, the second branch pipe 13 may be welded to the first branch pipe 8, or the first branch pipe 8 and the second branch pipe 13 may be molded from a single piece of iron or steel.

In embodiments of the subject invention, the second branch pipe 13 contains a mechanical joint connector comprising an integral flange 17, an integral shoulder 18 extending forwardly of the flange 17, and an integral spout 19 projecting forwardly of the shoulder 18. Elongated bolt-receiving passages 20 are formed in the flange 17. The spout 19 terminates in the outlet aperture 16.

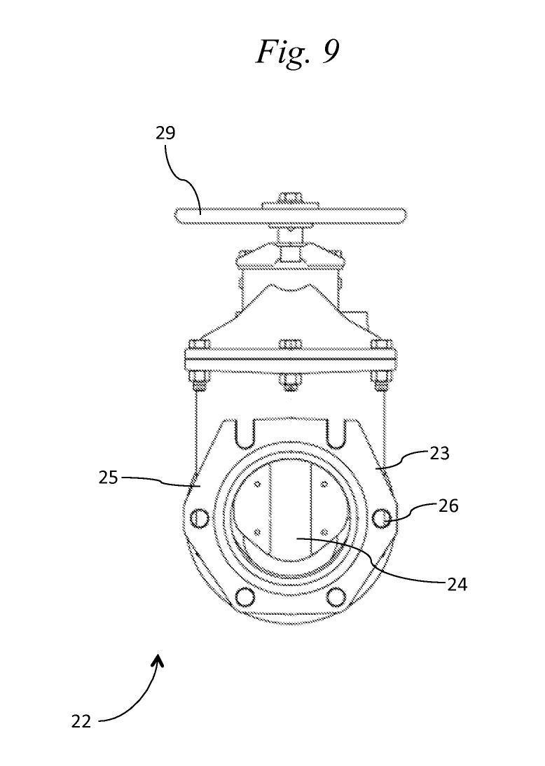

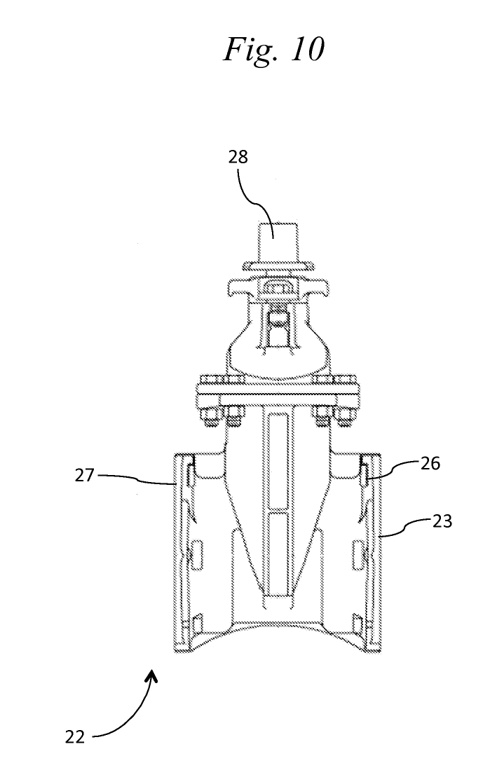

The second branch pipe 13 is connected to a mechanical joint gate valve by bolts (not shown) which extend through aligned bolt receiving passages 20 in the flange 17 and corresponding bolt receiving passages (not shown) in the mechanical joint flanges of the gate valve. A mechanical joint gasket 21 fits over the spout 19 of the second branch pipe 13. The mechanical joint valve connects the second branch pipe 13 to an outlet distribution pipe which is not shown, but which is conventional. In embodiments of the subject invention, the flange 17 and shoulder 18 may be welded to the second branch pipe 13 or molded from a single piece of iron or steel. In further embodiments of the subject invention, the spout 19 may be connected to a mechanical joint wedge gate valve 22, illustrated in FIGS. 9 and 10. The mechanical joint valve 22 may comprise a first mechanical joint 23 with an aperture 24 to fit over spout 19 and mechanical joint gasket 21. The first mechanical joint 23 further comprises a flange 25 and bolt receiving passages 26 for bolt connection onto flange 17 through bolt-receiving passages 20.

The mechanical joint wedge gate valve 22 may also comprise a second mechanical joint 27 for connection to an outlet distribution pipe, which is not shown. In further embodiments of the subject invention, the mechanical joint valve 22 may further comprise an operating nut 28, or a hand wheel 29. The body gaskets of mechanical joint wedge gate valve 22, not shown, shall be of the pressure energized O-ring style design.

During underground installation or repair of a supply or utility line in a tight, confined, and small spaces, the tap and sleeve 1 may be installed on a live fluid supply line. The body 2 of the tap and sleeve 1 is installed over the main fluid supply line such that the internal passage 4 is substantially aligned with the main fluid supply line, the first branch pipe 8 is on top of and rises in a substantially perpendicular direction from the main supply line, and the second branch pipe 13 extends four to five inches above the main supply line in a direction substantially perpendicular. In another embodiment of the subject invention, the first branch pipe 8 is on bottom of and extends below in a substantially perpendicular direction from the main supply line, and the second branch pipe 13 extends four to five inches below the main supply line in a direction substantially perpendicular. In either embodiment, fluid may flow from the main fluid supply line into the internal passage 4 of the body 2 through openings 5, through the internal opening into the first branch pipe 8, into the internal passage 15 of the second branch pipe 13 out the spout 17 and outlet aperture 16 into an outlet distribution pipe. The tapping process takes place on the top or bottom of the main fluid supply line to allow the water to come out the side, across from the main.

In embodiments of the subject invention, the modified tap and sleeve 1 is composed of stainless steel, carbon steel, or ductile iron.

1. A tapping sleeve assembly for direct connection to a fluid supply line, said assembly including: a first conduit; a second conduit attached to the first conduit in a first substantially perpendicular direction; a third conduit attached to the second conduit in a second substantially perpendicular direction, wherein the second substantially perpendicular direction is substantially perpendicular to the first substantially perpendicular direction and substantially perpendicular to the first conduit.

2. A tapping sleeve assembly for direct connection to a fluid supply line, said assembly including: a first conduit; a second conduit attached to the first conduit in a first direction that is substantially ninety degrees; a third conduit attached to the second conduit in a second direction, wherein the second direction is substantially ninety degrees to the first substantially perpendicular direction and substantially ninety degrees to the first conduit.

3. A tapping sleeve assembly for direct connection to a fluid supply line, said assembly including: a first conduit; a second conduit attached to the first conduit in a first direction that is at least seventy-five degrees; a third conduit attached to the second conduit in a second direction, wherein the second direction is at least seventy-five degrees to the first direction and at least seventy-five degrees to the first conduit.

4. The tapping sleeve assembly of claim 1, wherein each of the tapping sleeve assembly is comprised of machined steel.

5. The tapping sleeve assembly of claim 1, wherein the third conduit extends outwardly from the second conduit, four inches above the first conduit.

6. The tapping sleeve assembly of claim 1, wherein the third conduit comprises a gasket.

7. The tapping sleeve assembly of claim 1, wherein the second conduit comprises a gasket and a flange with bolt receiving passages therethrough.
